(19) United States
(12) Patent Application Publication
(10) Pub. No.: US 2012/0163671 A1
(43) Pub. Date: Jun. 28, 2012

(54) CONTEXT-AWARE METHOD AND APPARATUS BASED ON FUSION OF DATA OF IMAGE SENSOR AND DISTANCE SENSOR

(75) Inventors: Jeong-Dan CHOI, Daejeon (KR); Kyoung-Wook MIN, Daejeon (KR); Kyoung-Hwan AN, Daejeon (KR); Kyung-Bok SUNG, Daejeon (KR); Dong-Yong KWAK, Daejeon (KR); Dong-Sun LIM, Daejeon (KR)

(73) Assignee: Electronics and Telecommunications Research Institute, Daejeon (KR)

(21) Appl. No.: 13/331,318

(22) Filed: Dec. 20, 2011

(30) Foreign Application Priority Data
Dec. 23, 2010 (KR) 10-2010-0133943

(51) Int. Cl. G06K 9/34

(52) U.S. Cl. 382/104

(57) ABSTRACT

Disclosed herein are a context-aware method and apparatus. In the context-aware method, distance data is collected using a distance sensor. Thereafter, image data is collected using an image sensor. Thereafter, the distance data and the image data are fused with each other, and then context awareness is performed. Thereafter, safe driving management is performed based on the fusion of the data using the results of the context awareness.

### CROSS REFERENCE TO RELATED APPLICATION

This application claims the benefit of Korean Patent Application No. 10-2010-0133943, filed on Dec. 23, 2010, which is hereby incorporated by reference in its entirety into this application.

### BACKGROUND OF THE INVENTION

1. Technical Field

The present invention relates generally to context-aware technology capable of recognizing an actual context and, more particularly, to technology for recognizing the shapes of objects, such as an obstacle and a road sign, based on the fusion of the data of an image sensor and a distance sensor in order to support safe driving and walking services.

2. Description of the Related Art

Intelligent safety vehicle and unmanned autonomous driving technologies assist a driver in recognizing a road environment when the driver cannot accurately recognize the road environment because of the carelessness, fault and limited field of view of the driver, thereby preventing an accident from occurring or enabling a vehicle to move without requiring the manipulation of the driver.

In order to assist a driver in safely driving a vehicle, technology has been introduced that measures the distance to a vehicle which is moving forward and detects road conditions outside the field of view of the driver. In particular, a distance sensor, such as a laser radar or an ultrasonic sensor, has been introduced in order to detect obstacles, and a camera sensor or the like has been introduced in order to recognize objects.

That is, technology has been introduced that assists a driver in recognizing a variety of objects around a travelling vehicle using a variety of sensors mounted on the vehicle, such as a long-distance sensor (a radar) mounted on the front of a vehicle, a short-distance sensor mounted on a side or the rear of a vehicle, and a camera mounted on a side-view mirror.

However, the sensor using a camera has a serious problem from the aspect of reliability because the sensor erroneously recognizes the shadow of a vehicle as the vehicle itself and issues an erroneous alarm or no alarm as a result of direct sunlight, a reflective object, a rear strong light source, or a low illuminance environment.

Meanwhile, although the distance sensor can detect the shapes and existence of obstacles, its detection is limited because of hiding and is very deficient when used to recognize road signs or determine the level of danger of objects.

The above-described problems of the camera and the distance sensor are serious factors which hinder the development of technology for a driver assisting system. In particular, the distance sensor requires lots of technological improvements in order to implement unmanned vehicle service because it recognizes an inclined road or a speed bump as an obstacle, etc.

### SUMMARY OF THE INVENTION

Accordingly, the present invention has been made keeping in mind the above problems occurring in the prior art, and an object of the present invention is to provide a context-aware method and apparatus based on the fusion of the data of an image sensor and a distance sensor, in which the information of the distance sensor is fused with the information of the image sensor to help accurately recognize surrounding situations during driving, thereby reducing context-aware errors, such as a decrease in recognition rate attributable to a change in the brightness of road space, the failure to detect attributable to the characteristics of the material of an object, and the failure to detect attributable to the location of illumination.

Another object of the present invention is to provide a context-aware method and apparatus based on the fusion of the data of an image sensor and a distance sensor, in which the data of the image sensor and the distance sensor is fused to overcome the limitations of the two sensors, thereby enabling the shapes and features of obstacles to be accurately recognized.

Still another object of the present invention is to provide a context-aware method and apparatus based on the fusion of the data of an image sensor and a distance sensor, which are capable of preventing obstacles from not being accurately recognized because of a shadow or an illuminance condition.

In order to accomplish the above objects, the present invention provides a context-aware method, including collecting distance data using a distance sensor; collecting image data using an image sensor; fusing the distance data and the image data and then performing context awareness; and performing safe driving management based on the fusion of the data using results of the context awareness.

The performing context awareness may include performing context awareness by recognizing an object using contour points extracted from the distance data and raster data extracted from the image data.

The performing context awareness may include recognizing the object using object pattern information of a database management system in which attribute information about objects has been stored, the object being one of the objects.

The attribute information may include geometry information about each of the objects and danger level information about a level of danger resulting from a collision with each of the objects.

The performing context awareness may include determining whether the distance data and the image data correspond to a shadow; determining whether a situation in question is a low illuminance situation unsuitable for object recognition using the distance data and the image data; and recognizing the object as an obstacle.

The performing context awareness may include, if only the image data of the distance data and the image data corresponds to the object, determining that the object corresponds to the shadow.

The performing context awareness may include, if only the distance data of the distance data and the image data corresponds to the object, determining that the situation in question is the low illuminance situation.

The performing context awareness may include, if the situation in question is the low illuminance situation, recognizing the object using only the distance data of the distance data and the image data, controlling the image sensor so that the low illuminance situation is overcome, and collecting the image data again.

In order to accomplish the above objects, the present invention provides a context-aware apparatus, including a location and contour extractor for receiving distance data from a distance sensor and extracting contour points from the distance data; an image separator for receiving image data from an image sensor and extracting raster data from the image data; and a data fuser for fusing the contour points and the raster data with each other and performing context awareness.

The context-aware apparatus may further include a safe driving management unit for performing safe driving management based on the fusion of the data using results of the context awareness; and a database management system for storing attribute information about objects.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating blind spots attributable to the FOVs of image sensors;

FIG. 2 is a diagram illustrating the danger of accidents which may occur due to blind spots;

FIG. 3 is a diagram illustrating a blind spot which is generated when a truck turns right;

FIG. 4 is a photo showing the case where a driver cannot accurately be aware of surrounding situations because illumination is low;

FIG. 5 is a diagram illustrating the operating principle of a LiDAR (Light Detection And Ranging) sensor, that is, a kind of distance sensor;

FIG. 6 is views showing an example of the detection results of the LiDAR sensor in a road environment;

FIG. 7 is a diagram illustrating an example of the obstacle location determination equation of the LiDAR sensor, which is used to detect the obstacles, as shown in FIG. 6;

FIG. 8 is diagrams illustrating examples of errors that occur in the detection of obstacles when the distance sensor is used;

FIG. 9 is a block diagram illustrating a context-aware apparatus according to an embodiment of the present invention;

FIG. 10 is a block diagram illustrating the processing of image sensor data;

FIG. 11 is an operational flowchart illustrating a context-aware method using the fusion of data according to an embodiment of the present invention;

FIG. 12 is an operational flowchart illustrating an example of the step of performing context awareness as shown in FIG. 11;

FIG. 13 is an operational flowchart illustrating an example of the step of determining a shadow as shown in FIG. 12; and

FIG. 14 is an operational flowchart illustrating an example of the process of overcoming an illumination condition as shown in FIG. 12.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

The locations and sizes of moving obstacles in front of a vehicle, such as other vehicles or pedestrians, and fixed road signs and information about traveling possible/impossible areas are pieces of information which are very important to the safe driving of the vehicle.

The problem of an image sensor is that a blind spot is generated because its Field Of View (FOV) varies depending on its mounted location.

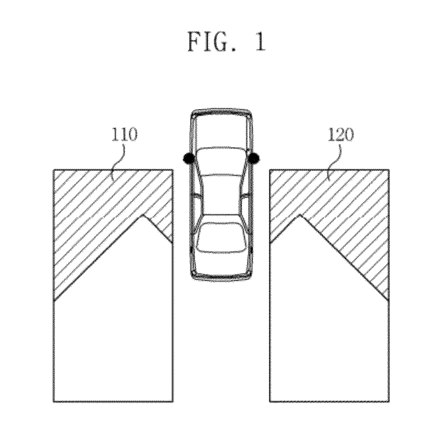

FIG. 1 is a diagram illustrating blind spots attributable to the FOVs of image sensors.

Referring FIG. 1, it can be seen that two blind spots 110 and 120 are generated depending on the locations of the image sensors.

It can be seen that the blind spots 110 and 120 which are generated when the image sensors shown in FIG. 1 are used are similar to blind spots which cannot be observed using the side-view mirrors of an existing vehicle.

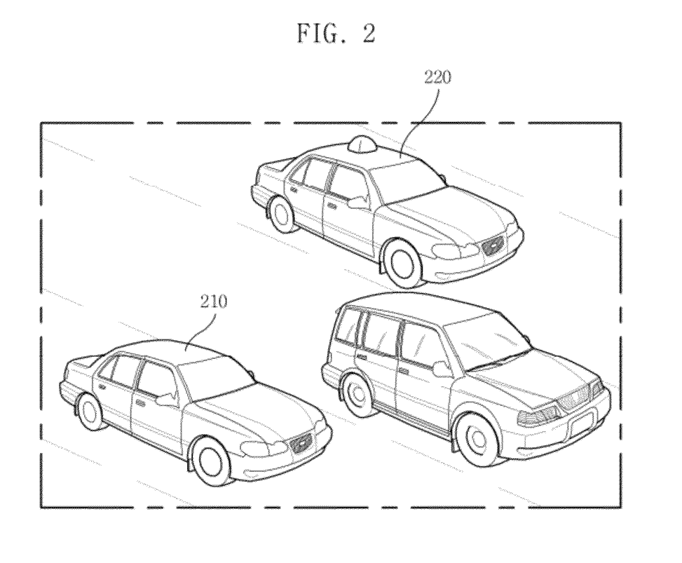

FIG. 2 is a diagram illustrating the danger of accidents which may occur due to blind spots.

Referring to FIG. 2, it can be seen that since vehicles 210 and 220 exist in blind spots, an accident may occur in the case of performing a driving maneuver, such as a lane change.

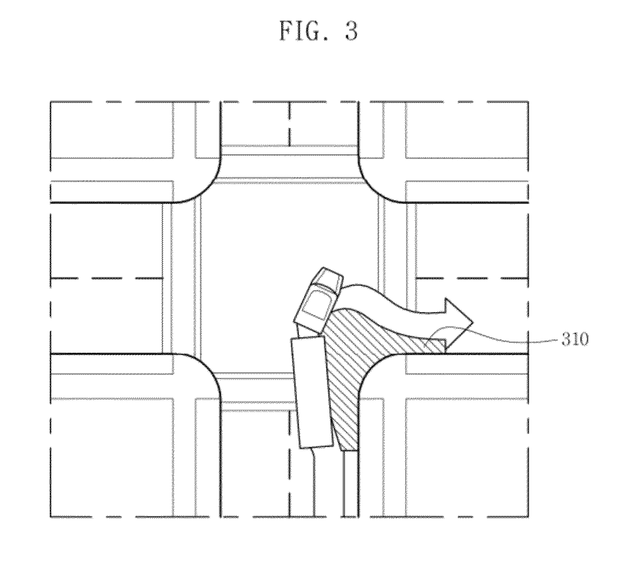

FIG. 3 is a diagram illustrating a blind spot which is generated when a truck turns right.

Referring to FIG. 3, it can be seen that when a truck turns right, a blind spot 310 is generated, and therefore a serious accident occurs if a pedestrian or a bike is in the blind spot 310.

FIG. 4 is a photo showing the case where a driver cannot accurately be aware of surrounding situations because of low illumination.

Referring to FIG. 4, it can be seen that when the minimum illuminance determined for each piece of hardware is not fulfilled, a camera sensor cannot be accurately aware of the context information around a driver.

To be accurately aware of surrounding context information during driving, two or more cameras may be mounted to play an auxiliary role, or an infrared camera, such as a night vision camera, may be utilized. However, in any of these cases, road environments, such as strong rear light or direct sunlight, cannot be overcome using only camera sensors.

A distance sensor may be an ultrasonic sensor or a radar sensor. An ultrasonic sensor is a device which generates ultrasonic waves for a predetermined period, detects signals reflected and returning from an object, and measures distance using a difference in time. An ultrasonic sensor is a device which is chiefly used to determine whether an obstacle, such as a pedestrian, exists within a relatively short distance range.

A radar sensor is a device which detects the location of an object using reflected waves which are generated by the propagation of radio waves when transmission and reception are performed at the same location. A radar sensor captures reflected waves and detects the existence of an object based on the phenomenon in which radio waves are reflected from a target when they collide with it. In order to prevent transmitted radio waves and received radio waves from not being distinguished from each other because they overlap each other, the Doppler effect may be utilized, the frequency of transmission radio waves may be varied over time, or pulse waves may be used as transmission radio waves. The distance to, direction toward, and altitude of a target object can be detected by moving an antenna to the right and left using a rotation device, and horizontal and vertical searching and tracking can be performed by arranging antennas vertically.

The most advanced distance sensor is a LiDAR sensor which is a non-contact distance sensor based on the principle of a laser radar. A LiDAR sensor operates in such a way as to convert the time, which it takes for a single emitted laser pulse to be reflected and return from the surface of an object within a sensor range, into distance, and therefore can accurately and rapidly recognize an object within the sensor range regardless of the color and shape of the object.

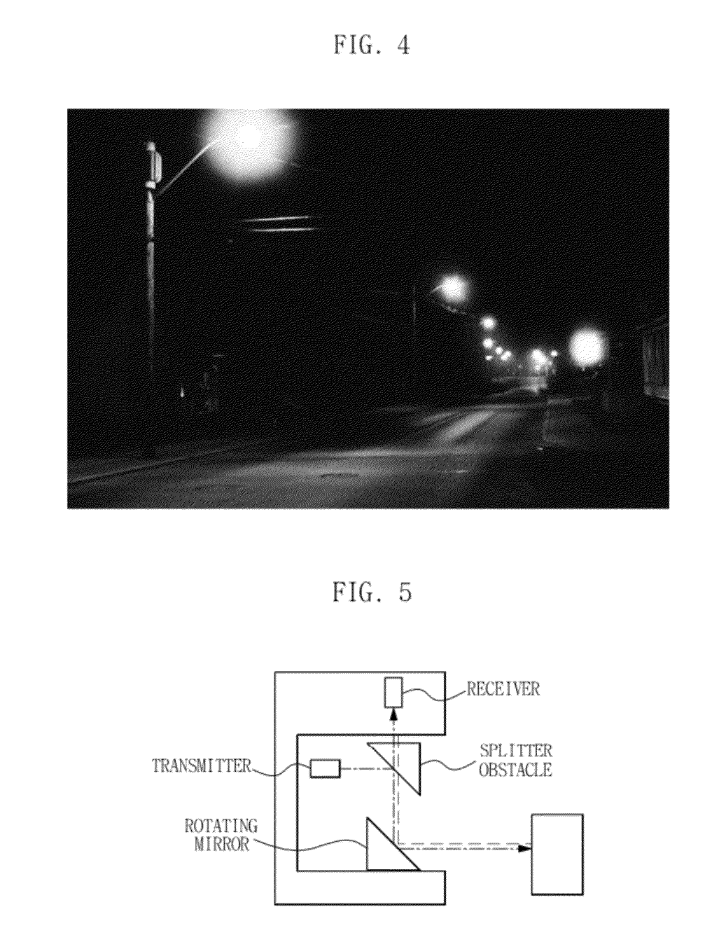

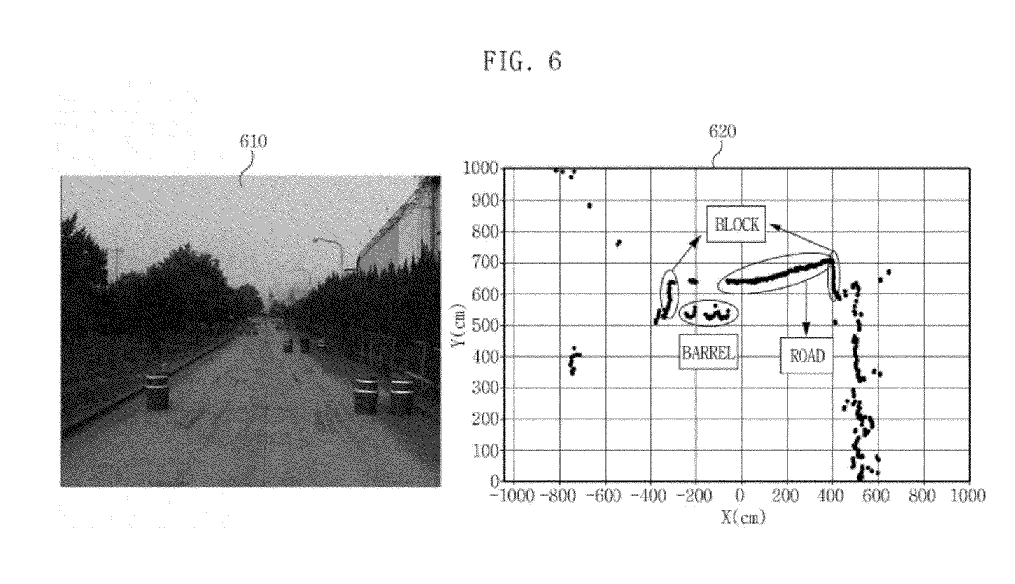

FIG. 5 is a diagram illustrating the operating principle of a LiDAR sensor, that is, a kind of distance sensor.

Referring to FIG. 5, it can be seen that the LiDAR sensor radiates light, generated by a transmission unit, onto a target object, receives light reflected from the target object, and measures the distance to the target object.

The distance sensor may be mounted on one of a variety of portions of a vehicle, including the top, side and front of a vehicle.

FIG. 6 is views showing an example of the detection results of the LiDAR sensor in a road environment.

Referring to FIG. 6, it can be seen that the results 620 of the detections of a road environment and obstacles in an actual environment 610 by means of the LiDAR sensor are plotted on a graph.

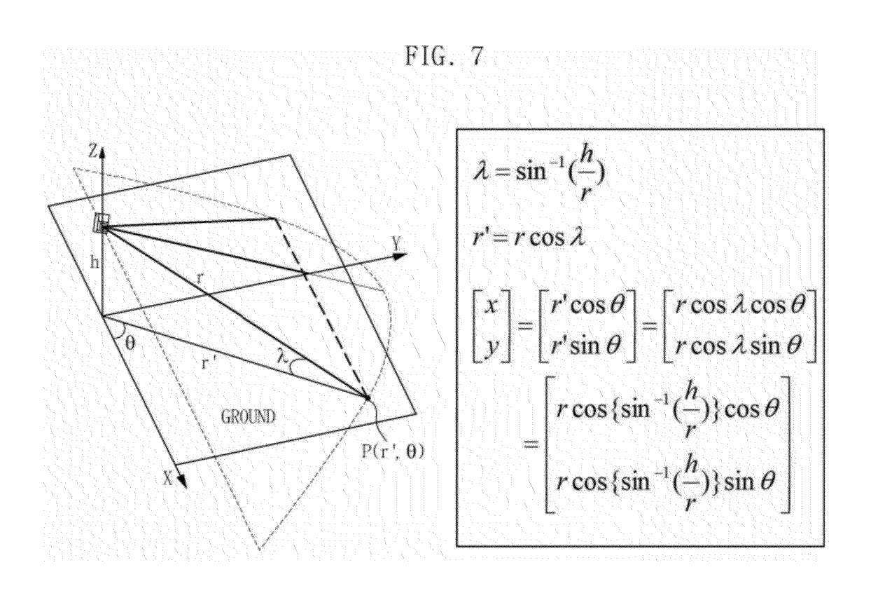

FIG. 7 is a diagram illustrating an example of the obstacle location determination equation of the LiDAR sensor, which is used to detect the obstacles, as shown in FIG. 6.

The locations of the obstacles detected by the LiDAR sensor can be determined using the equation shown in FIG. 7.

However, when only a LiDAR sensor is used, there occur cases where it is difficult to read road signs or where the irregularities of a road or speed bumps are detected as obstacles.

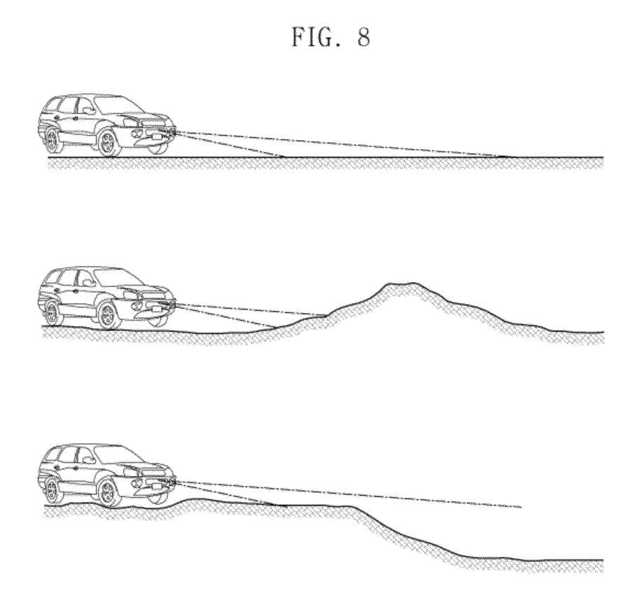

FIG. 8 is diagrams illustrating examples of errors that occur in the detection of obstacles when the distance sensor is used.

Referring to FIG. 8, it can be seen that when the distance sensor is used, a speed bump or an inclined road is detected as an obstacle. Furthermore, it is difficult to accurately determine whether a downhill road is a drivable road using only a LiDAR sensor.

In accordance with the present invention, the susceptibility of image sensors to an environment can be overcome using a distance sensor robust to illuminance and weather environment conditions, and the data of the image sensors are fused with the data of the distance sensor in order to improve the detection and accuracy of the distance sensor.

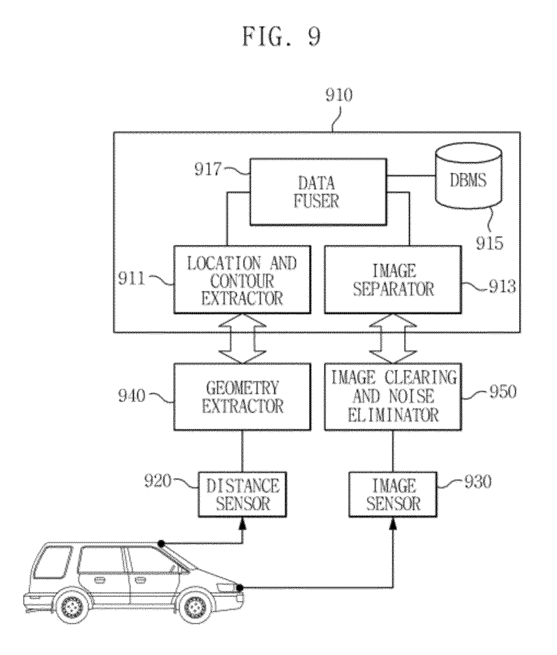

FIG. 9 is a block diagram illustrating a context-aware apparatus 910 according to an embodiment of the present invention.

Referring to FIG. 9, the context-aware apparatus 910 according to an embodiment of the present invention includes a location and contour extractor 911, an image separator 913, a data fuser 917, and a database management system (DBMS) 915.

The location and contour extractor 911 receives distance data via a distance sensor 920 and a geometry extractor 940.

The distance sensor 920 may be a radar sensor, an ultrasonic sensor or the like, and measures the distance to an object within a detection area.

The geometry extractor 940 receives the sensing results of the distance sensor 920, and generates distance data. Here, the distance data may be a set of points corresponding to the distance. For example, the distance data may be data about points which were input and scattered, or the results from which noise has been eliminated.

The image separator 913 receives image data via an image sensor 930 and an image clearing and noise eliminator 950.

The image sensor image sensor 930 senses a surrounding image using a camera or the like.

The image clearing and noise eliminator 950 generates image data by performing clearing processing and/or noise elimination processing on the image sensed by the image sensor 930.

Separate objects are extracted by applying vision technology, which separates overlapping objects, to image data that has been input into the image separator 913.

In this case, the distance sensor 920 and the image sensor 930 may be mounted on a vehicle or on road infrastructure.

The distance data and the image data output via the location and contour extractor 911 and the image separator 913, respectively, are fused with each other in the data fuser 917.

Geometry information about objects, which may be found in a road environment, and object attribute information, which includes the level of danger of the objects such as the level of impact which would occur should a vehicle collide with the objects, are stored in the database management system 915. In this case, the database management system 915 may also store pattern information about an object corresponding to each specific data attribute.

The data fuser 917 performs an algorithm for recognizing a specific object using contour points extracted using the location and contour extractor 911, the raster data of images separated using the image separator 913, and the object patterns stored in the database management system 915. That is, the data fuser 917 fuses the sensing results of the distance sensor 920 with the sensing results of the image sensor 930, and performs context awareness using the fused data.

Although not shown in FIG. 9, the context-aware apparatus may further include a safe driving management unit which manages safe driving using the results of context awareness, depending on the embodiment.

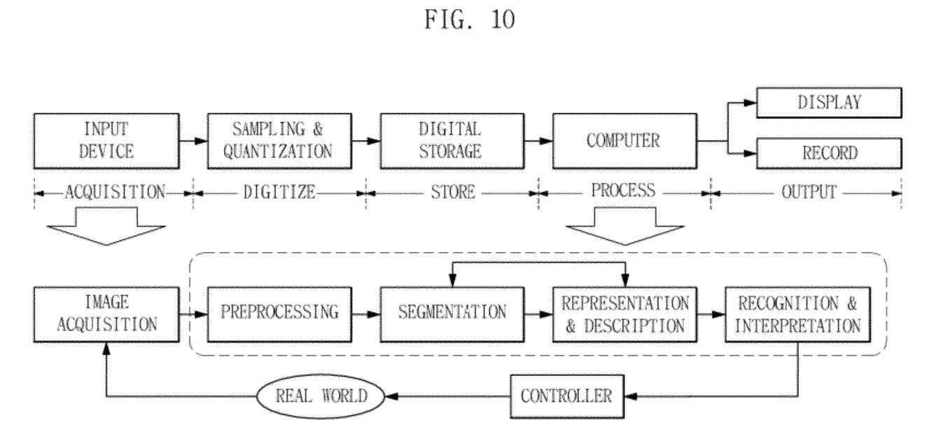

FIG. 10 is a block diagram illustrating the processing of image sensor data.

Referring to FIG. 10, image sensor data collected using the image sensor is subjected to preprocessing, including sampling, quantization and digitization, in order to perform image clearing. Furthermore, processing is performed on the digitized data. The processing includes the process of separating segments for respective objects and rendering and recognition processes. The process of separating segments and the process of performing recognition to perform rendering may be repeatedly performed until a necessary level is reached. As a result, the processing for performing recognition and reading can be performed on the stored images.

The recognized object is used by a controller to control a vehicle and therefore it can be applied to the real world. Safe driving management using the data of the image sensor can be performed by repeating the above-described process.

A distance can be extracted directly from the data sensed by the distance sensor 920. Furthermore, the data sensed using the distance sensor 920 is provided to the data fuser 917 in order to perform object processing using the process of distinguishing a road from an object.

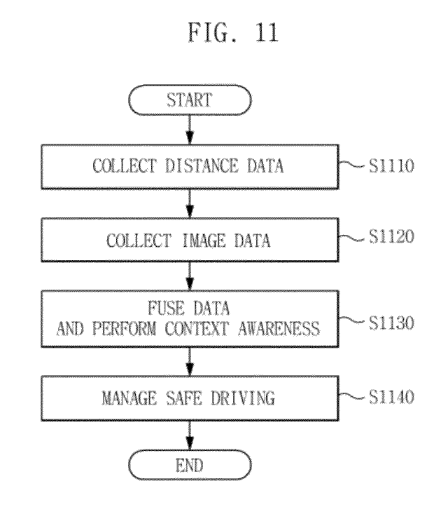

FIG. 11 is an operational flowchart illustrating a context-aware method using the fusion of data according to an embodiment of the present invention.

Referring to FIG. 11, in the context-aware method using the fusion of data according to the embodiment of the present invention, distance data is collected using a distance sensor at step S1110.

Here, the distance sensor may be a radar scanner sensor, an ultrasonic sensor, or the like.

Thereafter, image data is collected using an image sensor at step S1120.

Thereafter, the distance data and the image data are fused with each other and context awareness is performed at step S1130.

At step S1130, the context awareness may be performed by recognizing an object using contour points extracted from the distance data and raster data extracted from the image data.

Furthermore, at step S1130, the object may be recognized using the object pattern information of a database management system in which attribute information about objects has been stored. Here, the object is one of the objects.

Here, the attribute information may include geometry information about each of the objects and danger level information about the level of danger when a vehicle collides with each of the objects.

Thereafter, safe driving management based on the fusion of data is performed using the results of the context awareness at step S1140.

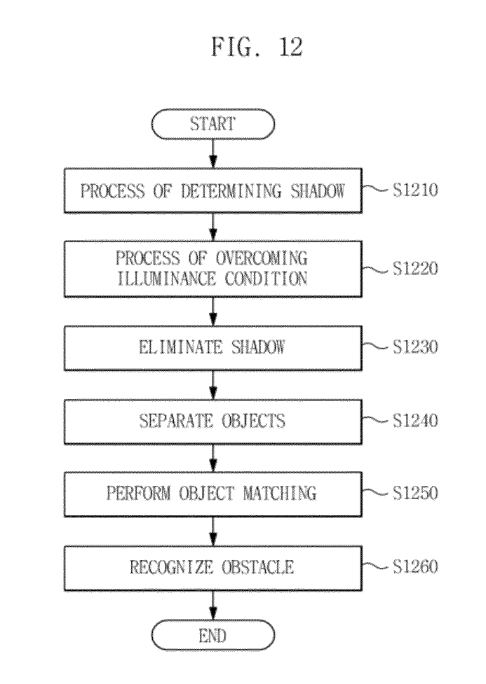

FIG. 12 is an operational flowchart illustrating an example of the step of performing context awareness shown in FIG. 11.

Referring to FIG. 12, at the step of performing context awareness, it is determined whether the distance data and the image data correspond to a shadow at step S1210.

Thereafter, the process of overcoming an illuminance condition is performed at step S1220. That is, at step S1220, whether a situation in question is a low illuminance situation unsuitable for the recognition of an object is determined using the distance data and the image data, and the process of overcoming low illuminance is performed if it is determined that a situation in question is a low illuminance situation.

Thereafter, if a shadow is found at step S1210, the shadow is eliminated to prevent the shadow from being recognized as an object at step S1230.

Thereafter, overlapping objects are separated using vision technologies at step S1240.

Thereafter, object matching is performed using any one of the distance data and the image data at step S1250.

Finally, an obstacle is recognized using the recognized object and safe driving management is performed in light of the recognized obstacle at step S1260.

The respective steps shown in FIG. 12 may correspond to the operations performed by the data fuser 917 shown in FIG. 9.

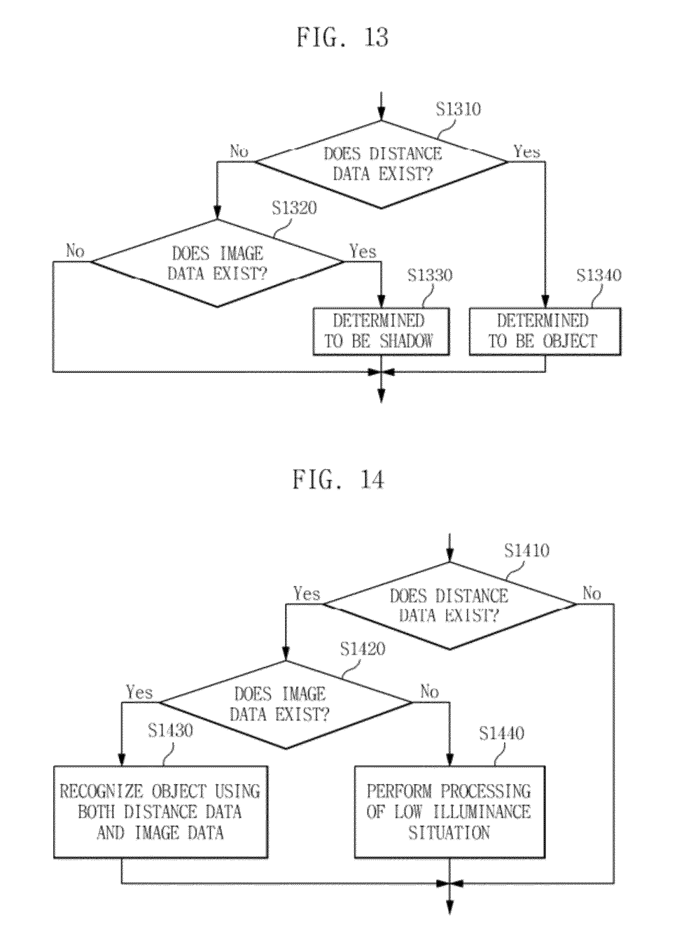

FIG. 13 is an operational flowchart illustrating an example of the step of determining a shadow shown in FIG. 12.

Referring to FIG. 13, at the step of determining a shadow, it is determined whether distance data corresponding to an object exists at step S1310.

If, as a result of the determination at step S1310, it is determined that the distance data does not exist, it is determined whether image data corresponding to the object exists at step S1320.

If, as a result of the determination at step S1310, it is determined that the distance data exists, it is determined that the distance data has been generated by the object at step S1340.

If, as a result of the determination at step S1320, it is determined that the image data corresponding to the object exists, an object does not actually exist but the image data has been detected because of a shadow, and therefore it is determined that the image data has been generated by the shadow at step S1330.

That is, at the step of determining a shadow, if only the image data of the distance data and the image data corresponds to the object, it is determined that the image data has been generated by a shadow.

FIG. 14 is an operational flowchart illustrating an example of the process of overcoming an illumination condition shown in FIG. 12.

Referring to FIG. 14, in the process of overcoming an illuminance condition, it is determined whether distance data corresponding to an object exists at step S1410.

If, as a result of the determination at step S1410, it is determined that the distance data corresponding to the object exists, it is determined whether image data corresponding to the object exists at step S1420.

If, as a result of the determination at step S1420, it is determined that the image data exists, object recognition is performed using both the distance data and the image data at step S1430.

If, as a result of the determination at step S1410, it is determined that the distance data does not exist, it is determined that the object does not exist, and therefore object recognition is not performed.

If, as a result of the determination at step S1420, it is determined that the image data does not exist, the processing of a low illuminance situation is performed at step S1440.

That is, in the process of overcoming low illuminance, if only the distance data of the distance data and the image data corresponds to the object, it is determined that an image sensor has not detected the object because of low illuminance.

For example, the processing of the low illuminance situation may be performed by extracting data contours and then recognizing an object using only distance data. In this case, control may be performed to improve the low illuminance condition, for example, by increasing the exposure of the image sensor, so that the image sensor can appropriately collect data when collecting data later.

Using the above-described context-aware method, the problem of erroneously recognizing the shadow of a vehicle as the vehicle itself and the problem of not accurately recognizing obstacle information using the image sensor because of a low illuminance condition can be overcome, and it is possible to achieve the accurate reading of road sign information and the appropriate context awareness of a hill or a downhill road.

The steps shown in FIGS. 11 to 14 may be performed in the illustrated sequence, in the reverse sequence, or at the same time.

The present invention has the advantage of overcoming the limitations of the image and distance sensor and thus achieving accurate and reliable context awareness because the data of the existing image sensor and the data of the existing distance sensor are fused with each other.

Furthermore, the present invention has the advantage of preventing the problem of erroneously recognizing a shadow as an obstacle such as a vehicle and the problem of not recognizing an obstacle because of an illuminance condition.

Furthermore, the present invention has the advantage of reading road sign information and the advantage of achieving appropriate context awareness regarding a hill and a downhill road.

Furthermore, the present invention has the advantage of taking appropriate measures because it can determine the level of danger of recognized situations using the object attribute information of the database management system.

Furthermore, the present invention has the advantage of reducing traffic accidents and ultimately reducing the socio-economic cost resulting from the traffic accidents.

Although the preferred embodiments of the present invention have been disclosed for illustrative purposes, those skilled in the art will appreciate that a variety of modifications, additions and substitutions are possible, without departing from the scope and spirit of the invention as disclosed in the accompanying claims.

What is claimed is:

1. A context-aware method, comprising:
collecting distance data using a distance sensor;
collecting image data using an image sensor;
performing context awareness by using fusing the distance data and the image data; and
performing safe driving management based on the fusion of the data, using results of the context awareness.

2. The context-aware method as set forth in claim 1, wherein the performing context awareness comprises performing context awareness by recognizing an object using contour points extracted from the distance data and raster data extracted from the image data.

3. The context-aware method as set forth in claim 2, wherein the performing context awareness comprises recognizing the object using object pattern information of a database management system in which attribute information about objects has been stored, the object being one of the objects.

4. The context-aware method as set forth in claim 3, wherein the attribute information comprises geometry information about each of the objects and danger level information about a level of danger resulting from a collision with each of the objects.

5. The context-aware method as set forth in claim 4, wherein the performing context awareness comprises:
determining whether the distance data and the image data correspond to a shadow;
determining whether a situation in question is a low illuminance situation unsuitable for object recognition using the distance data and the image data; and
recognizing the object as an obstacle.

6. The context-aware method as set forth in claim 5, wherein the performing context awareness comprises, if only the image data of the distance data and the image data corresponds to the object, determining that the object corresponds to the shadow.

7. The context-aware method as set forth in claim 6, wherein the performing context awareness comprises, if only the distance data of the distance data and the image data corresponds to the object, determining that the situation in question is the low illuminance situation.

8. The context-aware method as set forth in claim 7, wherein the performing context awareness comprises, if the situation in question is the low illuminance situation, recognizing the object using only the distance data of the distance data and the image data, controlling the image sensor so that the low illuminance situation is overcome, and collecting the image data again.

9. A context-aware apparatus, comprising:
a location and contour extractor for receiving distance data from a distance sensor and extracting contour points from the distance data;
an image separator for receiving image data from an image sensor and extracting raster data from the image data; and
a data fuser for fusing the contour points and the raster data with each other and performing context awareness.

10. The context-aware apparatus as set forth in claim 9, wherein the context-aware apparatus further comprises:
a safe driving management unit for performing safe driving management based on the fusion of the data using results of the context awareness; and
a database management system for storing attribute information about objects.

11. The context-aware apparatus as set forth in claim 10, wherein the data fuser recognizes the object using object pattern information of the database management system, the object being one of the objects.

12. The context-aware apparatus as set forth in claim 11, wherein the data fuser comprises a shadow processing unit for, if only the image data of the distance data and the image data corresponds to the object, determining that the distance data and the image data corresponds to a shadow.

13. The context-aware apparatus as set forth in claim 12, wherein the data fuser further comprises a low illuminance situation processing unit for determining that, if only the distance data among the distance data and the image data corresponds to the object, a situation in question is a low illuminance situation unsuitable for object recognition and recognizing the object using only the distance data.

14. The context-aware apparatus as set forth in claim 13, wherein the low illuminance situation processing unit, if it is determined that the situation in question is the low illuminance situation, controls an image sensor so that the low illuminance is overcome, and collects the image data again.
